(19) United States
(12) Patent Application Publication
(10) Pub. No.: US 2016/0149854 A1
(43) Pub. Date: May 26, 2016

(54) Framework for Application to Application Interworking in the M2M World

(71) Applicant: TELEFONAKTIEBOLAGET L M ERICSSON (PUBL), Stockholm (SE)

(72) Inventor: George Foti, Dollard des Ormeaux (CA)

(21) Appl. No.: 14/904,292

(22) PCT Filed: Jun. 16, 2014
(86) PCT No.: PCT/IB2014/062275

§ 371 Date: Jan. 11, 2016

Related U.S. Application Data
(60) Provisional application No. 61/845,677, filed on Jul. 12, 2013.

(51) Int. Cl. H04L 29/12; G06F 9/54; H04W 4/00

(52) U.S. Cl. CPC H04L 61/106; H04W 4/005; G06F 9/547; H04L 61/6004

(57) ABSTRACT

One aspect of the teachings herein is directed to a framework through which M2M applications can interact with each other, either through configuration or via autonomous interaction. In one example, the contemplated framework allows applications to publish their interfaces in a discoverable fashion, and allows the invocation of applications in a manner that allows for the retrieval of results of operations invoked on the target application. At least some embodiments protect the security and confidentiality of the information involved in those interactions.

### TECHNICAL FIELD

This disclosure relates generally to a mechanism to allow application discovery and invocation in a Machine-to-Machine, M2M, environment.

### BACKGROUND

As the number of Machine-to-Machine, M2M, devices increases and they become connected through data networks into a so-called Internet of things, there will be a proliferation of applications designed to perform specific and dedicated tasks. Some of these applications will be directed at tasks that make them beneficial for use by other applications, as opposed to end users. One such example of an application that is directed at serving other applications would be an application providing statistical functions for data classification. Such processing could be usefully exploited by other applications. Another example is applications that perform data mining using key words or other criteria, where such data mining can be used to serve results to other applications that have substantial amounts of data to process.

However, applications and their interactions within a M2M network domain differ, for example, from the types of applications that are often associated with and used by mobile devices, such as smartphones. In the smartphone context, applications are typically downloaded and used at the smartphone. In contrast, within a given M2M network, a first application may have knowledge of a second application, based on publication information available within the M2M network. Interaction between the two applications, e.g., where one application provides processing for the other one, is possible; but, to date there is no established framework for defining and implementing such interactions, e.g., on a standardized or common basis.

Correspondingly, it is recognized herein that a framework is needed to allow for interactions between M2M applications. Such a framework would, among other things, encourage inter-application development work.

### SUMMARY

One aspect of the teachings herein is directed to a framework through which M2M applications can interact with each other, either through configuration or via autonomous interaction. In one example, the contemplated framework allows applications to publish their interfaces in a discoverable fashion, and allows the invocation of applications in a manner that allows for the retrieval of results of operations invoked on the target application. At least some embodiments protect the security and confidentiality of the information involved in those interactions.

In one embodiment, a method provides for interworking between calling applications and called applications at a Services Capability Layer, SCL. The SCL resides in a network node operating in a M2M network and the method includes registering a first application at the SCL, which first application is a general-purpose application available for calling by other applications. The method further includes allocating an application data tree to the first application at the SCL, including binding the application data tree to an application identifier of the first application, and correspondingly allocating a publication container in the application data tree and storing calling information—such as Application Programming Interface information—for the first application in the publication container. Still further, the method includes notifying one or more second applications that are subscribed at the SCL for such notifications, as to the availability of the first application.

Further according to the method, the SCL receives, e.g., at some subsequent time, an application call from a given one of the second applications as a calling application. The application call targets the first application as a called application and the method correspondingly includes allocating input and output data containers in the application data tree for the called application. This allocation processing includes binding the input and output data containers to the calling application and to the application call and the method further includes storing input data from the calling application in the allocated input data container and indicating the availability of the input data to the called application, along with storing output data from the called application in the allocated output data container and indicating the availability of the output data to the calling application. The method additionally includes granting access to the output data in the allocated output data container responsive to verifying that an access request received at the SCL corresponds to the correct calling application and the correct application calling instance. For example, an application identifier and/or transaction identifier associated with access request may be checked to ensure matching with the application identifier and/or transaction identifier associated with the original application call.

In another example embodiment, a network node is configured to host an SCL in a M2M network. The network node includes a communication interface configured to send and receive inter-application signaling as between any number of applications that are registered at the SCL, and further includes a processing circuit and associated memory. The processing circuit is operatively associated with the communication interface and is operative to provide interworking between applications in a M2M network domain.

In that regard, the processing circuit of the network node is configured to register a first application at the SCL, where the first application is a general-purpose application available for calling by other applications. The processing circuit is further configured to allocate an application data tree to the first application at the SCL, and bind the application data tree to an application identifier of the first application, and to allocate a publication container in the application data tree and store calling information for the first application in the publication container. Additionally, the processing circuit is configured to notify one or more second applications that are subscribed at the SCL for such notifications, as to the availability of the first application, and to receive an application call from a given one of the second applications as a calling application.

The application call targets the first application as a called application, and the processing circuit is configured to allocate input and output data containers in the application data tree for the called application, and bind the input and output data containers to the calling application and to the application call. Further along these lines, the processing circuit is configured to store input data from the calling application in the allocated input data container and indicate the availability of the input data to the called application, store output data from the called application in the allocated output data container and indicate the availability of the output data to the calling application, and grant access to the output data in the allocated output data container responsive to verifying that a access request received at the SCL corresponds to the application call and application call.

In yet another example embodiment, a computer-readable medium stores a computer program that includes program instructions for execution by a processing circuit in a network node that is configured to host an SCL in a M2M network. The computer program includes program instructions to cause the network node to register a first application at the SCL, where the first application is a general-purpose application available for calling by other applications, and to allocate an application data tree to the first application at the SCL and bind the application data tree to an application identifier of the first application.

The stored computer program further includes instructions causing the node to allocate a publication container in the application data tree and store calling information for the first application in the publication container, notify one or more second applications that are subscribed at the SCL for such notifications, as to the availability of the first application and to receive an application call from a given one of the second applications as a calling application. Here, it will be understood that the stored program instructions are not the mechanism for triggering the application call, and “receive” as used in this context means that the stored program instructions enable the node to recognize and process an incoming application call that targets the first application as a called application.

Further, the stored computer program instructions include program instructions causing the node, e.g., by way of processing circuit operation, to allocate input and output data containers in the application data tree for the called application, bind the input and output data containers to the calling application and to the application call, store input data from the calling application in the allocated input data container, and indicate the availability of the input data to the called application. Additionally, the stored program instructions include program instructions causing the node to store output data from the called application in the allocated output data container and indicate the availability of the output data to the calling application, and grant access to the output data in the allocated output data container responsive to verifying that an access request received at the SCL corresponds to the application call.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of one embodiment of a Machine-to-Machine, M2M, network, wherein one or more network nodes are configured for application interworking according to the teachings herein.

FIG. 2 is a block diagram of example details for implementation of a network node configured for application interworking.

FIG. 3 is a diagram of one embodiment of a data structure as used by a network node taught herein, for application interworking.

FIG. 4 is a logic flow diagram of one embodiment of a method of application interworking, such as implemented by a network node in an M2M network.

FIGS. 5 and 6 are call or signaling flow diagrams illustrating example signal flows for one or more embodiments of application interworking in an M2M network.

### DETAILED DESCRIPTION

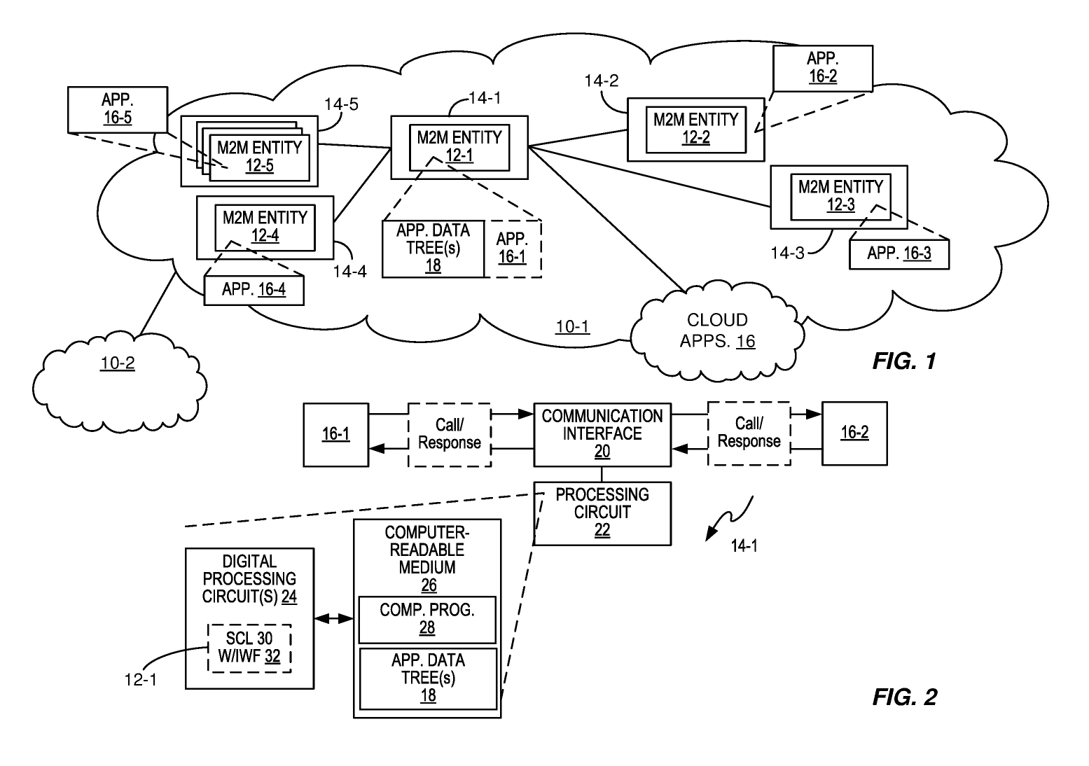

FIG. 1 illustrates a Machine-to-Machine, M2M, network 10-1, which also may be referred to as a “domain” The M2M network 10-1 may be communicatively coupled to one or more other M2M networks, with the M2M network 10-2 shown by way of example. A number of M2M entities 12 belong to and operate within the network 10-1. Each “M2M entity” is uniquely identified within the network 10-1. By way of example, the M2M entities 12 comprise various M2M applications and one or more Service Capability Layers or SCLs. While not explicitly illustrated, it will be understood that at least one of the M2M entities 12 in the diagram is configured as a Network SCL or N-SCL for the network 10-1. There may be other SCLs, too, such as SCLs at devices or gateways hosting or otherwise supporting one or more M2M applications. The physical nodes, e.g., devices, gateways, servers, etc., associated with the M2M entities 12 are illustrated as M2M network nodes 14.

The European Telecommunications Standards Institute or ETSI has promulgated a number of specifications that standardize various aspects of M2M networks. Among the numerous published specifications, the interested reader may refer to the following documents: TS 102 921, “Machine-to-Machine communications (M2M); mIa, dIa and mId interfaces”, TS 102 690, “Machine-to-Machine communications (M2M); Functional architecture”, and TR 102 725, “Machine-to-Machine communications (M2M); Definitions”. According the M2M architecture defined by ETSI, there are different device configuration connections, including a first configuration where an M2M device connects through a gateway that renders the device invisible to the N-SCL, which N-SCL may reside in a node within a core network, and a second configuration where devices directly connect to the M2M network and thus are visible to the N-SCL. Of course, any gateways connected to the M2M network, including gateways that hide secondarily connected M2M devices, are visible to the N-SCL. It will be understood that the various M2M applications—e.g., M2M applications hosted at devices or at other nodes within the M2M network—and SCLs, including Device SCLs, D-SCLs, Gateway SCLs, G-SCLs, and the aforementioned N-SCL, are all considered as being examples of the M2M entities 12 introduced in FIG. 1.

Turning back to the details of that figure, one sees M2M entities 12-1 through 12-5, and corresponding M2M nodes 14-1 through 14-5. However, any given node 14 may host more than one M2M entity 12, which is suggested by the “stack” of M2M entities 12 seen for the node 14-5. Further, while not explicitly shown in FIG. 1, there may be one or more nodes 14 hosting M2M entities 12 that are part of the network 10-1, but which are connected through one or more external access networks. In a non-limiting example of such a scenario, a wireless communication device operates as a node 14 hosting an M2M entity 12. The device includes a cellular communication interface used to connect to a cellular network, which in turn acts as an access network that communicatively couples the hosted M2M entity 12 to the network 10-1.

One also sees various applications 16—e.g., cloud applications 16, and individually illustrated applications 16-1, 16-2, 16-3, 16-4, and 16-5. For some nodes 14, the term “M2M entity 12” and “M2M application 16” may be synonymous. That is, the M2M entity 12 in question simply is a given M2M application 16. However, it should also be understood that any given node 14 may host multiple M2M entities 12, e.g., such as where more than one M2M application 16 is installed at the node 14, or such as where the node 14 implements a SCL that in turn hosts or at least manages one or more M2M applications 16. For example, it may be that the M2M entity 12-1 implemented at the node 14-1 is a SCL. Correspondingly, the application 16-1 is shown as a dashed box at the M2M entity 12-1, to denote that the application 16-1 is registered or otherwise affiliated with the SCL. In one example, the node 14-1 comprises a network server that implements a N-SCL and also hosts one or more applications 16.

One also sees one or more “application data trees 18” shown in association with the M2M entity 12-1. As will be detailed, the application data tree(s) 18 are data structures which, at least logically, may be understood as tree-like structures having branch and leaf data items that are used in the context of providing advantageous interaction between M2M applications 16 within the M2M network.

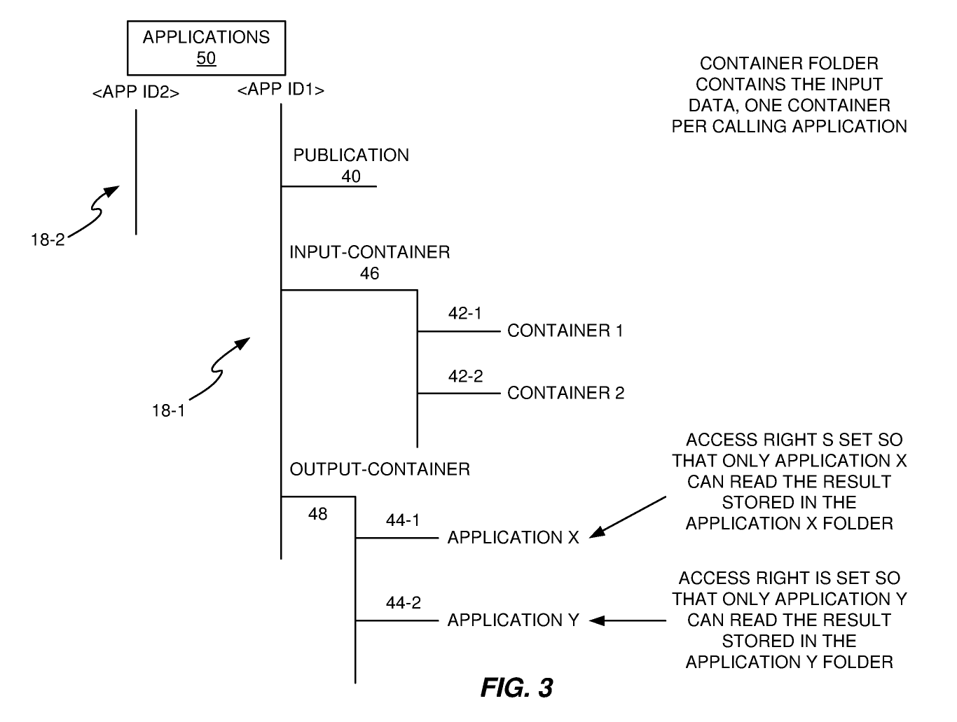

While its details may be applied to essentially any M2M entity 12 and supporting node 14 in the network 10-1, FIG. 2 continues the above context by illustrating example details for the M2M entity 12-1 in the node 14-1, as configured to support interaction between M2M applications 16. In this example case, there is at least one M2M application 16 within the M2M network that provides services or is otherwise available for use by one or more other applications 16. For purposes of discussion with respect to FIG. 2, one may assume that the M2M entity 12-1 implemented at the node 14-1 is an SCL, e.g., an N-SCL.

For example, in the diagram, the node 14-1 includes a communication interface 20 and a processing circuit 22 that comprises one or more digital processing circuits 24 and includes or is associated with a computer-readable medium (or media) 26 that stores the aforementioned application data tree(s) 18 and may be used to store a computer program 28. However configured, the processing circuit 22 implements an SCL 30 which includes or is associated with an interworking function, IWF, 32, enabling application interaction as contemplated herein. For convenience, the IWF 32 will not be referred to specifically, and instead general reference will be made to the SCL 30, which may be an N-SCL and which represents a specific example of the M2M entity 12-1 shown for the node 14-1 in FIG. 1.

The communication interface 20 is configured to send and receive inter-application signaling as between any number of applications 16 that are registered at the SCL 30. The processing circuit 22 is operatively associated with the communication interface 20 and is operative to provide interworking between applications 16 in the M2M network 10. Such functionality is based on the processing circuit 22 being configured to register a first application 16-1 at the SCL 30. In this example, the first application 16-1 is a general-purpose application 16 that is available for calling by other applications 16.

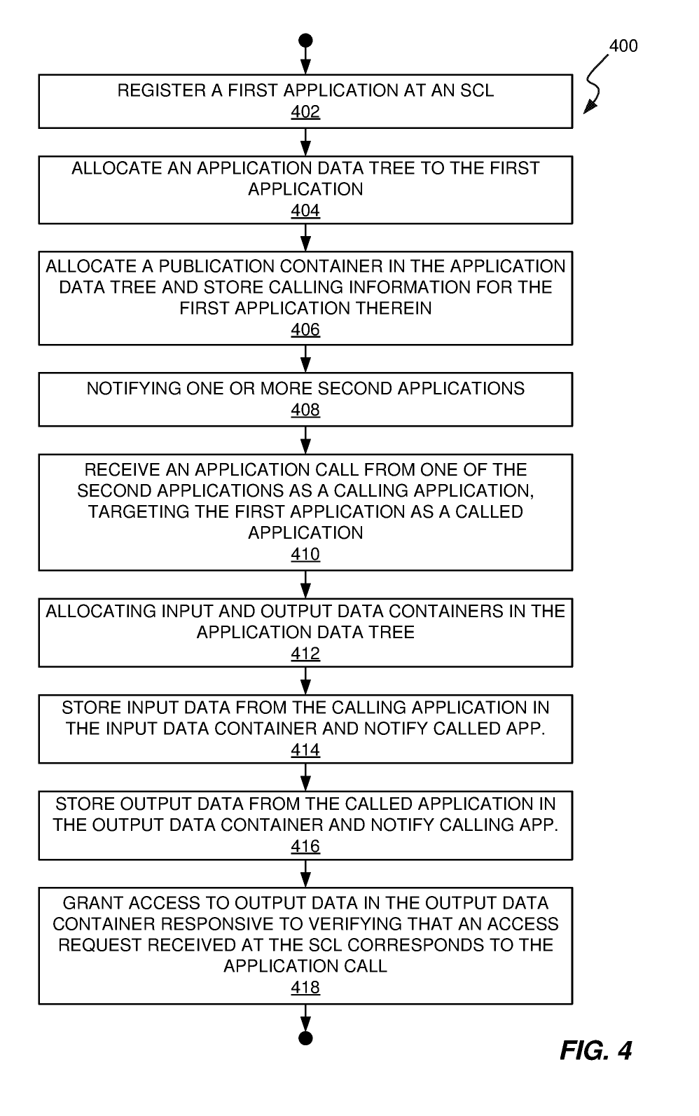

With reference to FIG. 3, the processing circuit 22 is further configured to allocate an application data tree 18-1 to the first application 16-1 at the SCL 30, and bind the application data tree 18-1 to an application identifier of the first application 16-1. The allocation may be a logical allocation within the working memory of the SCL 30, as instantiated by the processing circuit 22. The processing circuit 22 is further configured to allocate a publication container 40 in the application data tree 18-1 and store calling information for the first application 16-1 in the publication container 40. Still further, the processing circuit 22 is configured to notify one or more second applications 16 that are subscribed at the SCL 30 for such notifications, as to the availability of the first application 16-1. Here, it will be appreciated that “first” and “second” are labels of convenience and there may be any number of general-purpose applications 16 registered at the SCL 30, and any number of other applications 16 that are subscribed for publication notifications corresponding to such registration activity.

The processing circuit 22 is further configured to receive an application call from a given one 16-2 of the second applications 16 acting as a calling application, where the application call targets the first application 16-1 as a called application 16-1. Here, being “configured to receive” means that the processing circuit 22 is configured in such a way that it is operative to process, parse, or otherwise recognize application calls incoming to the SCL 30. Correspondingly, the processing circuit 22 is configured to allocate input and output data containers 42-1, 44-1 in the application data tree 18-1 for the called application 16-1, and bind the input and output data containers to the calling application 16-2 and to the application call.

Further, the processing circuit 22 is configured to store input data from the calling application 16-2 in the allocated input data container 42-1 and indicate the availability of the input data to the called application 16-1. The input data is, for example, data for processing by the called application 16-1. The processing circuit 22 is also configured to store output data from the called application 16-1 in the allocated output data container 44-1 and indicate the availability of the output data to the calling application 16-2, and to grant access to the output data in the allocated output data container 44-1 responsive to verifying that a access request received at the SCL 30 corresponds to the application call.

In at least some embodiments, the processing circuit 22 is configured to un-allocate at least one of the allocated input and output data containers 42-1, 44-1, responsive to determining that the calling application 16-2 has retrieved the output data from the allocated output data container 44-2.

In the same or other embodiments, the processing circuit 22 is configured to assign a transaction identifier to the application call and to verify that the access request—requesting access to the output data container 44-1—received at the SCL 30 corresponds to the application call, based on determining that a value received in association with the access request matches the assigned transaction identifier.

In the same or other embodiments, the processing circuit 22 is configured to verify that the access request received at the SCL 30 corresponds to the application call based on verifying that application identifiers associated with the access request match the application identifiers of the called and calling applications 16-1, 16-2, corresponding to the allocated output data container 44-1.

In another aspect applicable to at least some embodiments, the processing circuit 22 is configured to encrypt at least one of the allocated input and output data containers 42-1, 44-1, using a Public Key Infrastructure, PM, mechanism or a shared secret known to the SCL 30 and at least one of the calling and called applications 16-2, 16-1. For example, the calling application 16-2 and the called application 16-1 may have respective security certificates associated with them, or the SCL 30 may coordinate the use of a shared secret as between the SCL 30 and the called and calling applications 16-1, 16-2, and such keys or secret may be used to encrypt the contents of the corresponding input and output data containers 42-1 and 44-1, within the application data tree 18-1.

In the same or other embodiments, the processing circuit 22 is configured to allocate, as needed, additional application data trees 18 for additional general-purpose applications 16 that register at the SCL 30 and are available for calling by other applications 16. In particular, the processing circuit 22 is configured to manage all such application data trees 18 on a per-application basis—a per-called-application basis, responsive to receiving application calls directed to respective ones of the corresponding general-purpose applications 16. Such management includes, for each such application data tree 18, the processing circuit 22 being configured to allocate input and output data containers 42 and 44, as needed, for application calls directed to the corresponding general-purpose application 16. In at least one such embodiment, the processing circuit 22 is configured to aggregate all such application data trees 18 in an overall tree structure 50 maintained at the SCL 30, where each application data tree 18 comprises a respective branch of the overall tree structure 50.

In the context of such an approach, and continuing the prior example of the second application 16-2 calling the first application 16-1, and the corresponding allocation of first input and output data containers 42-1, 44-1 in the associated application data tree 18-1, the processing circuit 22 is configured to allocate the input and output data containers 42-1, 44-1 in the application data tree 18-1 for the called application 16-1, based on being configured to allocate the first input data container 42-1 as a further branch of a root input container branch 46. Here, the root input container branch 46 is associated with the application identifier of the called application 16-1. FIG. 3 illustrates an example identifier of “App ID1” for the application 16-1. The root input container branch 46 thus exists within the application data tree 18-1, which belongs to App ID1, and it contains all input data containers 42 allocated under the application data tree 18-1. The processing circuit 22 identifies the first application data container 42-1 under the root input container branch 46 according to the application identifier of the calling application 16-2.

Similarly, the processing circuit 22 is configured to allocate the first output data container 44-1 as a further branch of a root output container branch 48, where the root output container branch 48 is associated with the application identifier of the called application—App ID1—and contains all output data containers 44 allocated under the application data tree 18-1. The processing circuit 22 is configured to identify the first output data container 44-1 under the root output container branch according to the application identifier of the calling application 16-2.

Further, in at least some embodiments, the processing circuit 22 is configured to identify the first input and output data containers 42-1, 44-1 under the respective root input and output containers 46, 48 according to a transaction identifier associated with the application call, and to distinguish any additional input and output data containers 42, 44 allocated under the respective root input and output containers 46, 48 for additional application calls from the same calling application 16-2 according to additional transaction identifiers respectively associated with the additional application calls.

Thus, for a given first application 16 that is available for calling by other applications 16, the processing circuit 22 allocates a corresponding application data tree 18 that is logically bound to the application identifier—name, number, etc.—of the given application 16. Whenever another given second application 16 calls the first application 16—e.g., requests processing services provided by the first application 16—the processing circuit 22 allocates a corresponding input data container 42 under the root input container 46. As such, that allocated input data container 42 is logically bound to the identifiers of both the called and calling applications 16, and is further bound to a transaction identifier associated with the specific application call. Multiple, separate calls from the same calling application 16 would therefore result in the allocation of multiple, separate input data containers 42 under the root input container 46. Each such input data container 42 would “belong” to the same calling application 16, but could contain different input data for processing. Thus, the different transaction identifiers would distinguish these multiple input data containers 42 as being associated with different application calls. Corresponding logic is used for differentiating between different output data containers 44 under the root output container 48. While various transaction identifier arrangements are contemplated herein, in at least one embodiment there is a single transaction identifier for a given application call. That single identifier effectively binds the calling and called applications 16 and the corresponding input and output data containers 42 and 44 to the specific call.

The above arrangement advantageously provides input and output data repositories that belong to the calling/called applications 16, and access can be restricted on that basis. Moreover, the arrangement provides input and output data repositories that can be differentiated on a per-transaction basis, e.g., on a call instance basis. One sees a simple example of this functionality in FIG. 3, where the application data tree 18-1 corresponds to one called application 16, and application data tree 18-2 corresponds to another called application 16. The root input container 46 in the application data tree 18-1 has input data containers 42-1 and 42-2, which correspond to two different application calls, which calls could be from the same calling application 16, or from different calling applications 16. The input data container 42-1 has a counterpart output data container 44-1 under the root output container 48 and, likewise, the input data container 42-2 has a counterpart output data container 44-2. Each such container is bound, linked, or otherwise affiliated with the called application 16, the calling application 16, and a particular application call—i.e., to a particular transaction defined as a particular call instance by a calling application 16 to a called application 16. The processing circuit 22 therefore can condition or restrict data accesses based on application ID, call ID, transaction ID, etc.

The SCL 30 may generate transaction IDs in this regard, and may share the generated transaction IDs with the calling and called applications 16 for any given transaction. Alternatively, either the called or calling application 16 can provide a transaction ID, and the SCL 30 can be configured to ensure that the transaction ID is provided to the calling application 16 or to the called application 16, as needed. The transaction ID may be generated from time stamp and application ID information, for example, or it may be generated as nonce or other token.

Further, the processing circuit 22 is configured to perform memory management operations with respect to the application data trees 18. For example, in at least some embodiments, the processing circuit 22 is configured to un-allocate particular input and output data containers 42, 44 according to at least one of: determining that the corresponding calling and called applications 16 have successfully accessed the input and output data; determining that an allocation lifetime associated with the input and output data containers 42, 44 has expired; and determining that one or both of the calling and called applications 16 is no longer registered at the SCL 30.

It will be appreciated that the above processing-circuit functionality can be realized via execution of a computer program, e.g., a computer program for instantiating the SCL 30. Thus, in at least one embodiment, a computer-readable medium, such as the medium 26, stores a computer program 28. The computer program 28 includes program instructions for execution by a processing circuit 22 in a network node 14, where the node 14 is configured to host an SCL 30, in M2M network 10.

In particular, the computer program 28 includes program instructions to cause the network node 14-1 to: register a first application 16-1 at the SCL 30, where the first application 16-1 is a general-purpose application 16-1 available for calling by other applications 16; allocate an application data tree 18-1 to the first application 16-1 at the SCL 30, and bind the application data tree 18-1 to an application identifier of the first application 16-1; allocate a publication container 40 in the application data tree 18-1 and store calling information—e.g., API information—for the first application 16-1 in the publication container 40; notify one or more second applications 16 that are subscribed at the SCL 30 for such notifications, as to the availability of the first application 16-1; receive an application call from a given one 16-2 of the second applications 16 as a calling application 16-2, where the application call targets the first application 16-1 as a called application 16-1; allocate input and output data containers 42-1, 44-1 in the application data tree 18-1 for the called application 16-1, and bind the input and output data containers 42-1, 44-1 to the calling application 16-1 and to the application call; store input data from the calling application 16-2 in the allocated input data container 44-1 and indicate the availability of the input data to the called application 16-2; store output data from the called application 16-1 in the allocated output data container 44-1 and indicate the availability of the output data to the calling application 16-2; and grant access to the output data in the allocated output data container 44-1 responsive to verifying that an access request received at the SCL 30 corresponds to the application call.

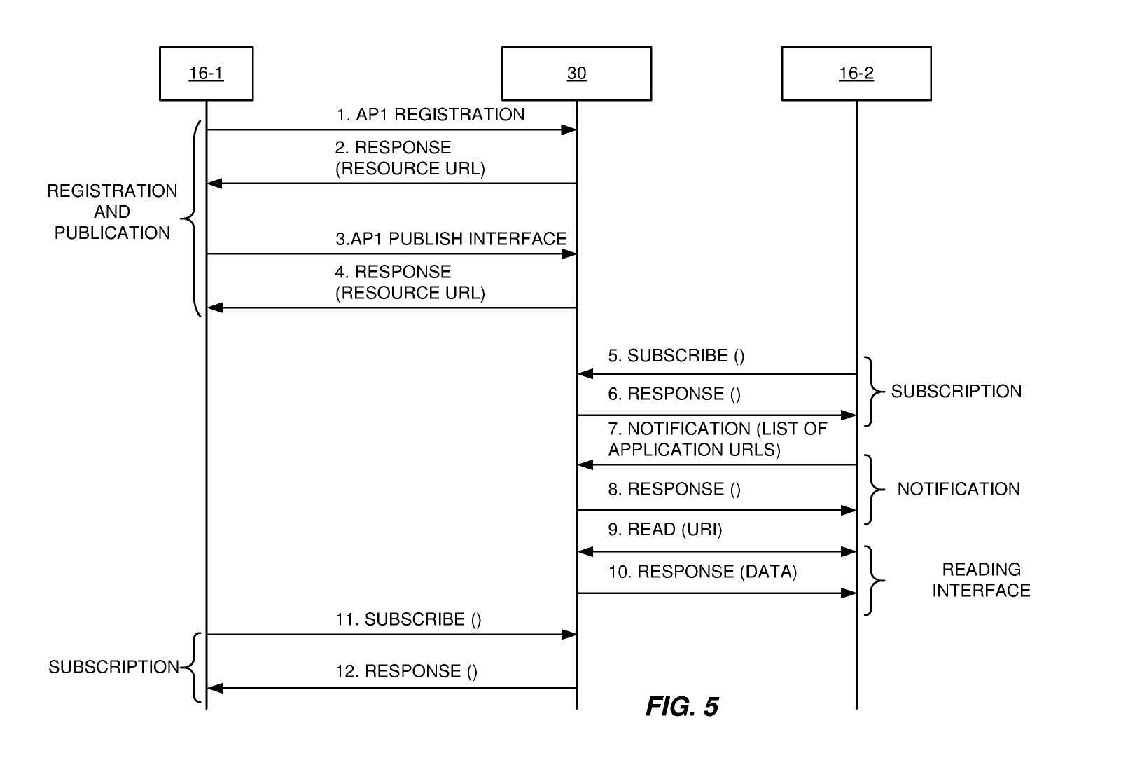

Regardless of the particular circuitry or other implementation details, the teachings herein shall be understood as providing a method of interworking between calling applications 16 and called applications 16 at a SCL 30, on a network node 14 in a M2M network 10. FIG. 4 illustrates an example embodiment of the contemplated method 400. According to these example details, the method 400 includes registering (Block 402) a first application 16-1 at the SCL 30, where the first application 16-1 is a general-purpose application 16 available for calling by other applications 16. The method 400 further includes allocating (Block 404) an application data tree 18-1 to the first application 16-1 at the SCL 30, including binding the application data tree 18-1 to an application identifier of the first application.

Still further, the method 400 includes allocating (Block 406) a publication container 40 in the application data tree 18-1 and storing calling information for the first application 16-1 in the publication container 40, and notifying (Block 408) one or more second applications 16 that are subscribed at the SCL 30 for such notifications, as to the availability of the first application 16-1. Correspondingly, the method 400 further includes receiving (Block 410) an application call from a given one 16-2 of the second applications 16 as a calling application 16-2. The application call targets the first application 16-1 as a called application 16-1.

In response to the application call, the method 400 includes allocating (Block 412) input and output data containers 42-1, 44-1 in the application data tree 18-1 for the called application 16-1. The allocation operations include binding the input and output data containers 42-1, 44-1 to the calling application 16-2 and to the application call—e.g., to a transaction ID generated or obtained for use in specifically differentiating the application call from other application calls. That is, a given calling application 16 may make more than one call—e.g., over time—to a given called application 16, and each application call is a different calling instance. Correspondingly, the method 400 includes storing (Block 414) input data from the calling application 16-2 in the allocated input data container 42-1 and indicating the availability of the input data to the called application 16-1, and storing (Block 416) output data from the called application 16-1 in the allocated output data container 44-1 and indicating the availability of the output data to the calling application 16-2. Further, the method 400 includes granting (Block 418) access to the output data in the allocated output data container 44-1 responsive to verifying that an access request received at the SCL 30 corresponds to the appropriate application call.

Verifying that the access request corresponds to the application call comprises, for example, verifying that a transaction ID provided with the access request matches one of the transaction IDs bound to one of the output data containers 44 allocated in an existing application data tree 18. In a more complete example, the verification includes verifying that the access request originates from an application 16 having the same application ID as was recorded in association with the transaction ID provided in the access request. The information used for this comparison-based verification is available in or in conjunction with the application data trees 18. Verification may additionally or alternatively be based on shared secrets, tokens, etc., such as may be used to uniquely identify given input and output data containers 42 and 44, and such as may be agreed-upon or otherwise shared, as needed, with calling and called applications 16 during the input/output container allocation or population operations.

As for carrying out the foregoing processing operations, the processing circuit 22 may comprise fixed circuitry, programmed circuitry, or some combination of both. FIG. 2 illustrates an example processing circuit 22 as comprising one or more digital processing circuits 24, which include or are associated with the computer-readable medium (or media) 26, e.g., for storing the application data trees 18, along with registration information, etc., as needed for SCL operations. In at least one embodiment, the computer-readable medium 26 stores a computer program product 28 comprising program instructions for execution by the processing circuit 22—i.e., a computer program implementing the above-described method 400.

Here, “stores” as used with respect to the computer program 28 shall be understood as meaning holding the program instructions for execution by the processor 22. As such, the computer-readable medium 26 cannot be understood as comprising a transitory propagating signal. However, the computer-readable medium 26 may, for example, comprise volatile memory, non-volatile memory, or any combination of both. Non-limiting examples of volatile memory include SRAM, and non-limiting examples of non-volatile memory include EEPROM, FLASH, Solid State Drive, etc. Corresponding examples of the one or more digital processing circuits 24 comprise one or more microprocessor circuits, Digital Signal Processor or DSP circuits, Field Programmable Gate Array or FPGA circuits, Application Specific Integrated Circuits or ASICs, Complex Programmable Logic Device or CPLD circuits, and/or other type of digital processing circuitry.

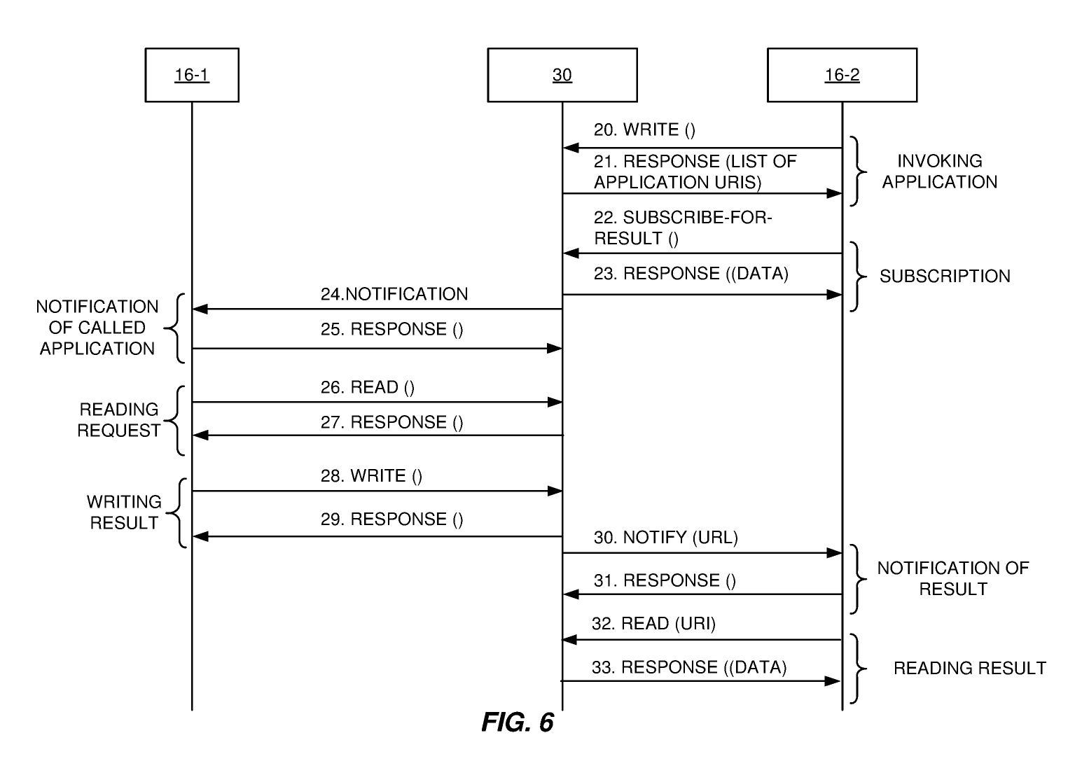

FIG. 5 illustrates an example call flow or signaling flow between first and second applications 16-1 and 16-2, as brokered by the SCL 30, which is a N-SCL in this example. The application 16-1 is a general-purpose application 16. Steps 1-4 of the signaling flow illustrate the registration of the application 16-1 with the SCL 30, and the corresponding publication of calling information—e.g., API information—at the SCL 30 for the application 16-1. Such data is placed in the publication folder 40 of the correspondingly allocated application data tree 18.

At Steps 5-10, one sees that the application 16-2 subscribes for notification of such registrations/publications, and the SCL 30 thus provides the application 16-2 with a list of all applications 16 and the references to their published information, as well as the Uniform Resource Indicator, URI, or Uniform Resource Locator, URL, for making calls to particular applications 16 of interest. In steps 9-10 the application 16-2 reads the published interface for the application 16-1, and in Steps 11-12 the application 16-1 subscribes at the SCL 30 for notifications of any application calls directed to it. In some embodiments, such a subscription is not needed, as the SCL 30 automatically notifies a called application 16 of any application calls directed to it. However, in at least some embodiments, the application data tree 18 and activities directed towards it are used as the triggering mechanism for interworking between calling and called applications 16.

For example, a “callable” application 16 subscribes to the SCL 30, to receive notifications of any input data containers 42 that created under its application data tree 18. Correspondingly, any application 16 that is a potential calling application can be provided with the resource information needed for such an application 16 to submit input data to the SCL 30, for creation of a corresponding input data container 42 under the application data tree 18 corresponding to the application 16 being called. Likewise, any calling application 16 can subscribe to the SCL 30 for notifications as to the availability of output data in any output data container 44 that is affiliated with the calling application 16. In such manner, the SCL 30 can send notifications as needed to calling and called applications 16, and use the data container structures to broker the exchange of input and output data between such applications 16 in a standardized manner.

The signaling flow diagram of FIG. 6 illustrates some aspects of the above interworking operations. In Steps 20 and 21, the application 16-2 issues a request to the application 16-1, by creating, or causing the SCL 30 to create, a new input data container 42 for its request under the application data tree 18 that belongs to the application 16-1. In Steps 22 and 23, the application 16-2 subscribes to the SCL 30, so that it is notified when the corresponding results are available in an output data container 44. The application ID shown is the application ID of the application 16-2 as a calling application.

In Steps 24 and 25, the SCL 30 notifies the application 16-1, as the called application, of the request from the application 16-2. In Steps 26 and 27, the application 16-1 reads the request, and then performs the necessary computations. In Steps 28 and 29, the application 16-1 copies the result to the proper location, for fetching by the application 16-2 as the calling application. Here, the proper location is the corresponding output data container 44 allocated in the application data tree 18 for this particular application call. In steps 30 and 31, the SCL 30 notifies the application 16-2 that the results are available. In steps 32-33, the application 16-2 reads the results from the output data container 44.

Thus, according to the teachings herein, a first type of application 16 within a M2M network 10 is general-purpose application, or at least is a type of application 16 that provides one or more services, such as computational services focused on resolving specific problems or performing specific types of data processing, to other applications 16. Such general-purpose applications 16 typically do not communicate with end-users or device applications, and instead represent resources that can be used by other applications 16. A second type of application 16 within the M2M network 10 is not intended for use by other applications—although it may interact with other applications, e.g., such as in a client-server relationship. Examples of this second type of applications 16 include those associated with specific industries, such as smart grid or smart metering industries, intelligent transport, e-health, etc. In FIGS. 5 and 6, the application 16-2 is of this second type, while the application 16-1 is of the first type.

Note that any given calling application 16 will preferably include its application ID or application instance ID as part of the calling procedure, to allow the SCL 30 or other M2M entity 12 to create an application-ID branch that allows the calling application 16 to retrieve its result; the access rights for each branch holding the result belonging to an application ID will preferably allow the application identified by the application ID to read the result. To accommodate multiple such requests originating from the same application ID, each request will preferably include a reference ID—i.e., the aforementioned transaction ID—that shall be copied to the result. This technique allows calling applications 16 to match results to requests. In this regard, it shall be understood that the application data tree structure 18 and the associated container creation and processing represent example implementation details, and the use of equivalent data structures is contemplated herein. In general, it is the bindings of application and/or transaction IDs to given input and output data sets that allow the SCL 30 or other implementing M2M entity 12 to broker the interactions between calling and called applications 16.

Broadly, the contemplated framework for interworking between applications 16 in an M2M network 10 provides a number of advantages. For example, it can make the services from any number of cloud-based applications 16 available to the applications 16 in or registered in a given M2M network 10. In such instances, the publication information, the input data and the output data for cloud applications 16 and calls to such cloud applications 16 are all managed in corresponding application data trees 18, or equivalent structures, and subscription-based notifications to the involved calling and called applications 16 can be triggered by the creation or population of publication containers 40, input data containers 42, and output data containers 44. Such processing allows any application 16, whether operating as a calling or called application, to rely on the implementing SCL 30 or other M2M entity 12, for facilitating the application interworking.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-21. (canceled)

22. A method of providing interworking between calling applications and called applications at a Services Capability Layer (SCL) on a network node in a Machine-to-Machine (M2M) network, said method comprising:
registering a first application at the SCL, said first application being a general-purpose application available for calling by other applications;
allocating an application data tree to the first application at the SCL, including binding the application data tree to an application identifier of the first application;
allocating a publication container in the application data tree and storing calling information for the first application in the publication container;
notifying one or more second applications that are subscribed at the SCL for such notifications, as to the availability of the first application;
receiving an application call from a given one of the second applications as a calling application, said application call targeting the first application as a called application;
allocating input and output data containers in the application data tree for the called application, including binding the input and output data containers to the calling application and to the application call;
storing input data from the calling application in the allocated input data container and indicating the availability of the input data to the called application;
storing output data from the called application in the allocated output data container and indicating the availability of the output data to the calling application;
granting access to the output data in the allocated output data container responsive to verifying that an access request received at the SCL corresponds to the application call.

23. The method of claim 22, further comprising, un-allocating at least one of the allocated input and output data containers responsive to determining that the calling application has retrieved the output data from the allocated output data container.

24. The method of claim 22, further comprising assigning a transaction identifier to the application call and wherein verifying that the access request received at the SCL corresponds to the application call comprises determining that a value received in association with the access request matches the assigned transaction identifier.

25. The method of claim 22, wherein verifying that the access request received at the SCL corresponds to the application call comprises verifying that application identifiers associated with the access request match the application identifiers of the called and calling applications corresponding to the allocated output data container.

26. The method of claim 22, further comprising encrypting at least one of the allocated input and output data containers using a Public Key Infrastructure (PKI) mechanism or a shared secret known to the SCL and at least one of the calling and called applications.

27. The method of claim 22, further comprising allocating, as needed, additional application data trees for additional general-purpose applications that register at the SCL and are available for calling by other applications, and managing all such application data trees on a per-application basis, responsive to receiving application calls directed to respective ones of the corresponding general-purpose applications, said managing including, for each such application data tree, allocating input and output data containers, as needed, for application calls directed to the corresponding general purpose application.

28. The method of claim 27, further comprising aggregating all such application data trees in an overall tree structure maintained at the SCL, wherein each application data tree comprises a respective branch of the overall tree structure.

29. The method of claim 22, wherein allocating the input and output data containers in the application data tree for the called application comprises:
allocating a first input data container as a further branch of a root input container branch, wherein the root input container branch is associated with the application identifier of the called application and contains all input data containers allocated under the application data tree, and identifying the first input data container under the root input container branch according to the application identifier of the calling application; and
allocating a first output data container as a further branch of a root output container branch, wherein the root output container branch is associated with the application identifier of the called application and contains all output data containers allocated under the application data tree, and identifying the first output data container under the root output container branch according to the application identifier of the calling application.

30. The method of claim 29, further comprising identifying the first input and output data containers under the respective root input and output containers according to a transaction identifier associated with the application call, such that additional input and output data containers allocated under the respective root input and output containers for additional application calls from the same calling application are distinguished according to the transaction identifier associated with each additional application call.

31. The method of claim 22, further comprising un-allocating the input and output data containers according to at least one of: determining that the calling and called applications have successfully accessed the input and output data; determining that an allocation lifetime associated with the input and output data containers has expired; and determining that one or both of the calling and called applications are no longer registered at the SCL.

32. A network node configured to host a Services Capability Layer (SCL) in a Machine-to-Machine (M2M) network, said network node comprising:
a communication interface configured to send and receive inter-application signaling as between any number of applications that are registered at the SCL;
and a processing circuit and associated memory, said processing circuit operatively associated with the communication interface and operative to provide interworking between applications in the M2M network based on being configured to:
register a first application at the SCL, said first application being a general-purpose application available for calling by other applications;
allocate an application data tree to the first application at the SCL, and bind the application data tree to an application identifier of the first application;
allocate a publication container in the application data tree and store calling information for the first application in the publication container;
notify one or more second applications that are subscribed at the SCL for such notifications, as to the availability of the first application;
receive an application call from a given one of the second applications as a calling application, said application call targeting the first application as a called application;
allocate input and output data containers in the application data tree for the called application, and bind the input and output data containers to the calling application and to the application call;
store input data from the calling application in the allocated input data container and indicate the availability of the input data to the called application;
store output data from the called application in the allocated output data container and indicate the availability of the output data to the calling application;
grant access to the output data in the allocated output data container responsive to verifying that a access request received at the SCL corresponds to the application call.

33. The network node of claim 32, wherein the processing circuit is configured to un-allocate at least one of the allocated input and output data containers responsive to determining that the calling application has retrieved the output data from the allocated output data container.

34. The network node of claim 32, wherein the processing circuit is configured to assign a transaction identifier to the application call and to verify that the access request received at the SCL corresponds to the application call, based on determining that a value received in association with the access request matches the assigned transaction identifier.

35. The network node of claim 32, wherein the processing circuit is configured to verify that the access request received at the SCL corresponds to the application call based on verifying that application identifiers associated with the access request match the application identifiers of the called and calling applications corresponding to the allocated output data container.

36. The network node of claim 32, wherein the processing circuit is configured to encrypt at least one of the allocated input and output data containers using a Public Key Infrastructure (PKI) mechanism or a shared secret known to the SCL and at least one of the calling and called applications.

37. The network node of claim 32, wherein the processing circuit is configured to allocate, as needed, additional application data trees for additional general purpose applications that register at the SCL and are available for calling by other applications, and manage all such application data trees on a per-application basis, responsive to receiving application calls directed to respective ones of the corresponding general-purpose applications, said managing including, for each such application data tree, said processing circuit being configured to allocate input and output data containers, as needed, for application calls directed to the corresponding general-purpose application.

38. The network node of claim 37, wherein the processing circuit is configured to aggregate all such application data trees in an overall tree structure maintained at the SCL, wherein each application data tree comprises a respective branch of the overall tree structure.

39. The network node of claim 32, wherein the processing circuit is configured to allocate the input and output data containers in the application data tree for the called application based on being configured to:
allocate a first input data container as a further branch of a root input container branch, wherein the root input container branch is associated with the application identifier of the called application and contains all input data containers allocated under the application data tree, and identify the first input data container under the root input container branch according to the application identifier of the calling application; and
allocate a first output data container as a further branch of a root output container branch, wherein the root output container branch is associated with the application identifier of the called application and contains all output data containers allocated under the application data tree, and identify the first output data container under the root output container branch according to the application identifier of the calling application.

40. The network node of claim 39, wherein the processing circuit is configured to identify the first input and output data containers under the respective root input and output containers according to a transaction identifier associated with the application call, and to distinguish any additional input and output data containers allocated under the respective root input and output containers for additional application calls from the same calling application according to additional transaction identifiers respectively associated with the additional application calls.

41. The network node of claim 32, wherein the processing circuit is further configured to un-allocate the input and output data containers according to at least one of: determining that the calling and called applications have successfully accessed the input and output data; determining that an allocation lifetime associated with the input and output data containers has expired; and determining that one or both of the calling and called applications is no longer registered at the SCL.

42. A non-transitory computer-readable medium storing a computer program comprising program instructions for execution by a processing circuit in a network node configured to host a Services Capability Layer (SCL) in a Machine-to-Machine (M2M) network, said computer program comprising program instructions to cause the network node to:
register a first application at the SCL, said first application being a general-purpose application available for calling by other applications;
allocate an application data tree to the first application at the SCL, and bind the application data tree to an application identifier of the first application;
allocate a publication container in the application data tree and store calling information for the first application in the publication container;
notify one or more second applications that are subscribed at the SCL for such notifications, as to the availability of the first application;
receive an application call from a given one of the second applications as a calling application, said application call targeting the first application as a called application;
allocate input and output data containers in the application data tree for the called application, and bind the input and output data containers to the calling application and to the application call;
store input data from the calling application in the allocated input data container and indicate the availability of the input data to the called application;
store output data from the called application in the allocated output data container and indicate the availability of the output data to the calling application; and
grant access to the output data in the allocated output data container responsive to verifying that an access request received at the SCL corresponds to the application call.
